(19) United States
(12) Patent Application Publication
(10) Pub. No.: US 2013/0244519 A1
(43) Pub. Date: Sep. 19, 2013

(54) FLAME RESISTANT BACKSHEET FOR SOLAR CELL MODULES

(71) Applicants: MINFANG MU, Shanghai (CN); Qiuju Wu, Shanghai (CN); Philip L. Boydell, Challex (FR)

(72) Inventors: MINFANG MU, Shanghai (CN); Qiuju Wu, Shanghai (CN); Philip L. Boydell, Challex (FR)

(73) Assignee: E I DU PONT DE NEMOURS AND COMPANY, Wilmington, DE (US)

(21) Appl. No.: 13/608,105

(22) Filed: Sep. 10, 2012

(30) Foreign Application Priority Data
Sep. 21, 2011 (CN) 201110289701.8

(51) Int. Cl. B32B 27/02

(52) U.S. Cl. CPC B32B 27/02
USPC 442/136

(57) ABSTRACT

Disclosed herein is a flame resistant flexible backsheet for solar cell modules, which comprises (a) a flame resistant layer formed of a non-metal inorganic fiber fabric; and (b) a first polymeric layer that is adhered to a first side of the flame resistant layer. Further disclosed herein is a solar cell module comprising the flame resistant flexible backsheet.

### FIELD OF DISCLOSURE

The present disclosure is related to flame resistant flexible backsheets for solar cell modules.

### BACKGROUND

Photovoltaic (PV) modules (also known as solar cell modules) are used to produce electrical energy from sunlight, offering an environmentally friendly alternative to traditional methods of electricity generation. Such modules are based on a variety of semiconductor cell systems that can absorb light and convert it into electrical energy and are typically categorized into one of two types of modules based on the light absorbing material used, i.e., bulk or wafer-based modules and thin film modules.

Generally, individual cells are electrically connected to form a module, and an array of modules can be connected together in a single installation to provide a desired amount of electricity. When the light absorbing semiconductor material in each cell, and the electrical components used to transfer the electrical energy produced by the cells, are suitably protected from the environment, photovoltaic modules can last 25, 30, and even 40 or more years without significant degradation in performance. In a typical photovoltaic module construction, the solar cell layer is sandwiched between two encapsulant layers, which layers are further sandwiched between a frontsheet and a backsheet. It is desirable that the frontsheets and backsheets have good weather resistance, UV resistance, moisture barrier properties, and electrical insulating properties.

Solar cell modules are often times being installed on roof tops and, more recently, are being used as parts of building structures, such as building envelopes, roofs, skylights, or facades. Accordingly, there is a need to provide solar cell modules with improved flame resistance.

Non-metal inorganic materials such as mica, glass fibers, and ceramic fibers are well-known flame resistant materials and they have been made into fire proof or fire resistant sheets or plates. However, not all kinds of non-metal inorganic materials are suitable to be included in the backsheet structures of solar cell modules. For example, as demonstrated below, although mica sheet has superior flame resistant properties, the inclusion thereof in the backsheets can compromise the bonding integrity of the backsheets and thereby reduce the durability of the solar cell modules. Therefore, there is still a need to develop a laminated flame resistant backsheet structure that has good bonding integrity and is useful in solar cell modules.

### SUMMARY

Provided herein is a flame resistant flexible backsheet for solar cell modules, which comprises: (a) a flame resistant layer formed of a non-metal inorganic fiber fabric; and (b) a first polymeric layer that is adhered to a first side of the flame resistant layer.

In one embodiment of the flame resistant flexible backsheet, the non-metal inorganic fiber fabric is made from long continuous non-metal inorganic fibers, and wherein the long continuous non-metal inorganic fibers are formed of a material selected from the group consisting of silica, boron oxide, aluminum silicate, alumino borosilicate, calcium silicate, magnesium silicate, silicon carbide, zirconium carbide, potassium titanates, aluminum borosilicates, anthophyllite, amphibole, serpentine and aluminum oxide, magnesium oxide, calcium oxide, zirconium oxide, titanium oxide, or combinations of two or more thereof. Or, the non-metal inorganic fiber fabric is selected from the group consisting of woven fabrics, non-woven fabrics, and knitted fabrics. Or, the non-metal inorganic fiber fabric is a woven fabric made from long continuous non-metal inorganic fibers selected from glass fibers, ceramic fibers, and combinations thereof.

In a further embodiment of the flame resistant flexible backsheet, the flame resistant layer has a thickness of 0.01-5 mm, or 0.01-4 mm, or 0.05-3 mm.

In a yet further embodiment of the flame resistant flexible backsheet, the first polymeric layer is formed of a composition comprising a polymeric material selected from the groups consisting of fluoropolymers, polyesters, polycarbonates, polyolefins, ethylene copolymers, polyvinyl butyrals, norbornene copolymers, polystyrenes, styrene-acrylate copolymers, acrylonitrile-styrene copolymers, polyacrylates, polyethersulfones, polysulfones, polyamides, polyurethanes, acrylics, cellulose acetates, cellulose triacetates, cellophanes, polyvinyl chlorides, vinylidene chloride copolymers, epoxy, and combinations of two or more thereof. Or, the first polymeric layer is formed of a composition comprising a fluoropolymer or a polyester.

In another embodiment of the flame resistant flexible backsheet, the backsheet further comprises (c) a second polymeric layer that is adhered to a second side (which is an opposite side from the first side) of the flame resistant layer. The first and second polymeric layer may be independently formed of a composition comprising a polymeric material selected from the groups consisting of fluoropolymers, polyesters, polycarbonates, polyolefins ethylene copolymers, polyvinyl butyrals, norbornene copolymers, polystyrenes, styrene-acrylate copolymers, acrylonitrile-styrene copolymers, polyacrylates, polyethersulfones, polysulfones, polyamides, polyurethanes, acrylics, cellulose acetates, cellulose triacetates, cellophanes, polyvinyl chlorides, vinylidene chloride copolymers, epoxy, and combinations of two or more thereof. Each of the first and second polymeric layers may be independently formed of a composition comprising a fluoropolymer or a polyester.

In a further embodiment of the flame resistant flexible backsheet the fluoropolymer mentioned above may be selected from the group consisting of homopolymers and copolymers of vinyl fluorides (VF), vinylidene fluorides (VDF), tetrafluoroethylenes (TFE), hexafluoropropylenes (HFP), chlorotrifluoroethlyenes (CTFE), and combinations of two or more thereof. Preferably the fluoropolymer is selected from the group consisting of polyvinyl fluorides (PVF), polyvinylidene fluorides (PVDF), polytetrafluoroethylene (PTFE), ethylene chlorotrifluoroethlyene copolymers (ECTFE), ethylene tetrafluoroethylene copolymers (ETFE), and combinations of two or more thereof. More preferably the fluoropolymer is selected from the group consisting of PVF, PVDF, and combinations thereof, and yet more preferably, the fluoropolymer is PVF. The polyester may be selected from the group consisting of polyethylene terephthalate (PET), polybutylene terephthalate (PBT), polyethylene trimethylene terephthalate (PTT), polyethylene naphthalates (PEN), and combinations of two or more thereof. Preferably the polyester is PET.

In one embodiment of the flame resistant flexible backsheet, the flame resistant layer is formed of a woven glass fiber fabric, and the first polymeric layer is formed of a composition comprising a fluoropolymer. The second polymeric layer may be formed of a composition comprising a polyester.

In another embodiment of the flame resistant flexible backsheet, the flame resistant layer is formed of a woven ceramic fiber fabric, the first polymeric layer is formed of a composition comprising a fluoropolymer, and the second polymeric layer is formed of a composition comprising a polyester.

In another embodiment of the flame resistant flexible backsheet, the backsheet further comprises one or more adhesive layers, and each of the one or more adhesive layers is disposed between any pair of adjacent layers. And, each of the one or more adhesive layers may be independently formed of an adhesive material selected from the group consisting of reactive adhesives and non-reactive adhesives. Preferably the reactive adhesives are selected from the group consisting of polyurethanes, acrylics, epoxy, polyimides, silicones, and combinations of two or more thereof and the non-reactive adhesives are preferably selected from polyethylenes, polyesters, and combinations thereof. The one or more adhesive layers may be independently formed of an adhesive material selected from polyurethanes and ethylene copolymers.

Further provided herein is a solar cell module comprising a solar cell layer formed of one or a plurality of solar cells, a back encapsulant layer laminated to a back side of the solar cell layer, and a backsheet laminated to a back side of the back encapsulant layer, wherein the backsheet is formed of the flame resistant flexible backsheet described above.

In one embodiment of the solar cell module, the module further comprises a front encapsulant layer laminated to a front side of the solar cell layer and a transparent frontsheet laminated to a front side of the front encapsulant layer.

In accordance with the present disclosure, when a range is given with two particular end points, it is understood that the range includes any value that is within the two particular end points and any value that is equal to or about equal to any of the two end points.

### BRIEF DESCRIPTION OF DRAWINGS

FIG. 1 is a not-to-scale cross-sectional view of one embodiment of the flame resistant backsheet disclosed herein.

FIG. 2 is a not-to-scale cross-sectional view of a further embodiment of the flame resistant backsheet disclosed herein.

FIG. 3 is a not-to-scale cross-sectional view of a yet further embodiment of the flame resistant backsheet disclosed herein.

FIG. 4 is a not-to-scale cross-sectional view of a yet further embodiment of the flame resistant backsheet disclosed herein.

FIG. 5 is a not-to-scale cross-sectional view of one embodiment of the solar cell module disclosed herein.

### DETAILED DESCRIPTION

Referring now to FIG. 1, disclosed herein is a flame resistant flexible backsheet (10) for solar cell modules, which comprises: (a) a flame resistant layer (11) that is formed of a non-metal inorganic fiber fabric; and (b) at least one polymeric layer (12) that is formed of a polymeric film or sheet and is adhered to the flame resistant layer (11), and wherein the non-metal inorganic fiber fabric is made from long continuous non-metal inorganic fibers. By “adhered”, it is meant that the two film or sheet layers are bonded together directly or indirectly. In those embodiments wherein the two film or sheet layers are bonded together indirectly, there may be adhesive or other layers positioned and bonded between the two layers.

The term “long continuous fibers” used herein refers to long filaments or fibers having a general aspect ratio (defined as the ratio of fiber length to diameter) of 200 or higher. For example, the long continuous non-metal inorganic fibers used herein may have an average diameter of about 100 μm or lower, or about 50 μm or lower, or about 30 μm or lower.

The long continuous non-metal inorganic fibers used herein may be made of any suitable non-metal inorganic material. Exemplary non-metal inorganic materials used herein may include, without limitation, silica, metal oxides having a formula of MₓO_{y} (with M being a metal and x and y being integers), and derivatives of silica or metal oxides. In one embodiment, the non-metal inorganic materials used herein are selected from silica, boron oxide, aluminum silicate, alumino borosilicate, calcium silicate, magnesium silicate, silicon carbide, zirconium carbide, potassium titanates, aluminum borosilicates, anthophyllite, amphibole, serpentine or aluminum oxide, magnesium oxide, calcium oxide, zirconium oxide, titanium oxide, and combinations of two or more thereof. Any suitable process may be used to prepare the long continuous non-metal inorganic fibers. For example, the long continuous non-metal inorganic fibers may be prepared by (1) converting the non-metal inorganic materials into a homogeneous melt at high temperature; (2) extruding the melt through bundles of very small orifices to form multiple filaments; (3) optionally sizing the filaments with a chemical solution; and (4) bundling the individual filaments together in large numbers to provide a roving. Such rovings may then be used in making the non-metal inorganic fiber fabrics used herein.

Preferably, the long continuous non-metal inorganic fibers used herein are selected from glass fibers, ceramic fibers, graphite fibers, carbon fibers, asbestos fibers, boron fibers, silica fibers, silica carbide fibers, and combinations of two or more thereof. More preferably, the long continuous non-metal inorganic fibers used herein are selected from glass fibers, ceramic fibers, and combinations of two or more thereof.

The long continuous non-metal inorganic fibers used herein may also be obtained commercially from various venders, which may include, without limitation, glass fibers available from Owens Corning (U.S.A.) under the trade name ADVANTEX™; silicon carbide continuous fibers available from Nippon Carbon Co., Ltd. (Japan) under the trade name NICALON™; silicon carbide fibers available from Special Materials Inc. (U.S.A.) under the trade name SCS-6™ and SCS-Ultra™; ceramic fibers available from 3M (U.S.A.) under the trade name 3M™ NEXTEL™; and ceramic fibers available from Unifrax Co. (U.S.A.) under the trade name FIBERFRAX™.

The non-metal inorganic fiber fabrics used herein in forming the flame resistant layer (11) may be any suitable types of fabrics made from any long continuous non-metal inorganic fibers disclosed hereabove. For example, the non-metal inorganic fiber fabrics may be selected from woven, non-woven, and knitted fabrics. Suitable woven fiber fabrics include, without limitation, plain weave, basket weave, leno weave, twill weave, crow-foot satin, and long shaft satin. Suitable knit fabrics include, without limitation, warp knits and weft knits. Preferably, the non-metal inorganic fiber fabrics are selected from woven and knitted fabrics. More preferably, the non-metal inorganic fiber fabrics are woven fabrics.

Also, the non-metal inorganic fiber fabrics may be undergone surface treatments to improve performance. For example, the non-metal inorganic fiber fabrics used herein may be heat treated to remove undesirable volatile and/or organic materials. Or, the non-metal inorganic fiber fabrics used herein may be surface coated with varnish, silicone rubber, fluoropolymers (e.g., TEFLON® fluoropolymers available from E.I. du Pont de Nemours and Company (U.S.A.) (hereafter “DuPont”)), or polychloroprenes (e.g., NEOPRENE® polychloroprenes available from DuPont).

The non-metal inorganic fiber fabrics used here may also be obtained commercially from various venders, which may include, without limitation, quartz fiber fabrics available from JPS Composite Materials Corp. (U.S.A.) under the trade name ASTROQUARTZ™; ceramic fiber cloth available from Isolite Insulating Products Co., Ltd. (Japan), Morgan Thermal Ceramics (U.S.A.), or YESO Insulating Products Co., Ltd. (China); and fiber glass sheets available from Shaanxi HuaTek Fiberglass Material Group Co., Ltd. (China), Hongda Glassfiber Cloth Company (Renqiu City, Hebei Province, China), or Shengzhen Sailong Fiberglass Company Ltd. (China).

Also, in accordance to the present disclosure, the flame resistant layer (11) may have a thickness of about 0.01-5 mm, or about 0.01-4 mm, or about 0.05-3 mm.

The polymeric layer (12) that is adhered to the flame resistant layer (11) may be formed of any suitable polymeric film or sheet. The compositions used in making the polymeric films or sheets may comprise any one or more polymeric materials selected from fluoropolymers, polyesters, polycarbonates, polyolefins (including, e.g., polypropylene, polyethylene), ethylene copolymers (including, e.g., ethylene vinyl acetates (EVA), ethylene acrylic acid copolymers, ethylene acrylic ester copolymers, ionomers), poly(vinyl butyral) (PVB), norbornene copolymers, polystyrenes, styrene-acrylate copolymers, acrylonitrile-styrene copolymers, polyacrylates, polyethersulfones, polysulfones, polyamides, polyurethanes (PU), acrylics, cellulose acetates, cellulose triacetates, cellophanes, polyvinyl chlorides, vinylidene chloride copolymers, epoxy, and combinations of two or more thereof. In one embodiment, the polymeric film or sheet used herein is made from a composition comprising a fluoropolymer or a polyester.

The fluoropolymers used herein are polymers made from at least one fluorinated monomer (fluoromonomer) (i.e., wherein at least one of the monomers contains fluorine, preferably an olefinic monomer with at least one fluorine or a perfluoroalkyl group attached to a doubly-bonded carbon). The fluorinated monomer may be selected from, without limitation, tetrafluoroethylene (TFE), hexafluoropropylene (HFP), chlorotrifluoroethylene (CTFE), trifluoroethylene, hexafluoroisobutylene, perfluoroalkyl ethylene, fluorovinyl ethers, vinyl fluoride (VF), vinylidene fluoride (VF2), perfluoro-2,2-dimethyl-1,3-dioxole (PDD), perfluoro-2-methylene-4-methyl-1,3-dioxolane (PMD), perfluoro (allyl vinyl ether), and perfluoro (butenyl vinyl ether). In one embodiment, the fluoropolymers used herein are selected from homopolymers and copolymers of vinyl fluorides (VF), vinylidene fluorides (VDF), tetrafluoroethylenes (TFE), hexafluoropropylenes (HFP), chlorotrifluoroethlyenes (CTFE), and combinations of two or more thereof. In a further embodiment, the fluoropolymers used herein are selected from polyvinyl fluorides (PVF), polyvinylidene fluorides (PVDF), polytetrafluoroethylene (PTFE), ethylene chlorotrifluoroethlyene copolymers (ECTFE), ethylene tetrafluoroethylene copolymers (ETFE), and combinations of two or more thereof. In a yet further embodiment, the fluoropolymers used herein are selected from PVF, PVDF, and combinations thereof.

In one embodiment, the polymeric layer (12) is formed of a PVF film or sheet that consists essentially of PVF. PVF is a thermoplastic fluoropolymer with repeating units of —(CH₂CHF)ₙ—. PVF may be prepared by any suitable process, such as those disclosed in U.S. Pat. No. 2,419,010. In general, PVF has insufficient thermal stability for injection molding and is thus usually made into films or sheets via a solvent extrusion or casting process. In accordance with the present disclosure, PVF films or sheets used herein may be prepared by any suitable process, such as casting or solvent assisted extrusion. For example, U.S. Pat. No. 2,953,818 discloses an extrusion process for the preparation of films from orientable PVF and U.S. Pat. No. 3,139,470 discloses a process for preparing PVF films.

Suitable PVF films or sheets used herein are more fully disclosed in U.S. Pat. No. 6,632,518. The PVF films or sheets used herein may also be obtained commercially, e.g., from DuPont under the trade name Tedlar®.

In a further embodiment, the polymeric layer (12) is formed of a PVDF film or sheet consisting essentially of PVDF. PVDF is a thermoplastic fluoropolymer with repeating units of —(CH₂CF₂)ₙ—. Commercially available oriented PVDF films, include, without limitation, Kynar™ PVDF films from Arkema Inc. (U.S.A.) and Denka DX films from Denka Group (Japan).

The polyesters used herein are those polymers containing the ester functional group in their main chain. Suitable polyesters may include, without limitation, polyethylene terephthalate (PET), polybutylene terephthalate (PBT), polyethylene trimethylene terephthalate (PTT), polyethylene naphthalates (PEN), and combinations of two or more thereof. In one embodiment, the polyesters used herein are PET.

Suitable polyester films used herein in forming the polymeric layer (12) may be prepared by any suitable sheet or film forming process, such as hot-melt extrusion, blown film extrusion, casting, calendaring, and the like. Suitable polyester films (e.g., PET films) may also be purchased from DuPont Teijin Films under the trade name Mylar® or Toray Plastics (U.S.A.), Inc. under the trade name Lumirror™.

The compositions forming the polymeric films or sheets used herein may further comprise minor amounts of any additives known within the art. Such additives include, without limitation, plasticizers, processing aids, flow enhancing additives, lubricants, pigments, dyes, flame retardants, impact modifiers, nucleating agents, antiblocking agents (e.g., silica), thermal stabilizers, hindered amine light stabilizers (HALS), UV absorbers, UV stabilizers, dispersants, surfactants, chelating agents, coupling agents, adhesives, primers, reinforcement additives (e.g., glass fiber, fillers), and the like.

The thickness of the polymeric layer (12) is not critical and may be varied depending on the particular application. Generally, when fluoropolymer (e.g., PVF) is used, the thickness of the polymeric layer (12) may be about 2.5-254 μm, or about 5-100 μm, or about 10-50 μm; while when polyester (e.g., PET) is used, the thickness of the polymeric layer (12) may be about 10-800 μm, or about 50-500 μm, or about 70-250 μm.

In accordance with the present disclosure, the flame resistant flexible backsheet (10) may further comprise any additional film or sheet layers other than the flame resistant layer (11) and the at least one polymeric layer (12), provided that the integrity and the flame resistant properties thereof is not negatively affected. Such other additional film or sheet layers may be selected from glass sheet layers, other additional polymeric layers, and other additional flame resistant layers (including additional flame resistant layers formed of non-metal inorganic fiber fabrics).

For example, in one embodiment (see FIG. 2), the flame resistant flexible backsheet (10′) comprises two polymeric layers (12 and 13) that are adhered to each side of the flame resistant layer (11), and each of the two polymeric layers may be independently formed of any suitable polymeric films or sheets described above.

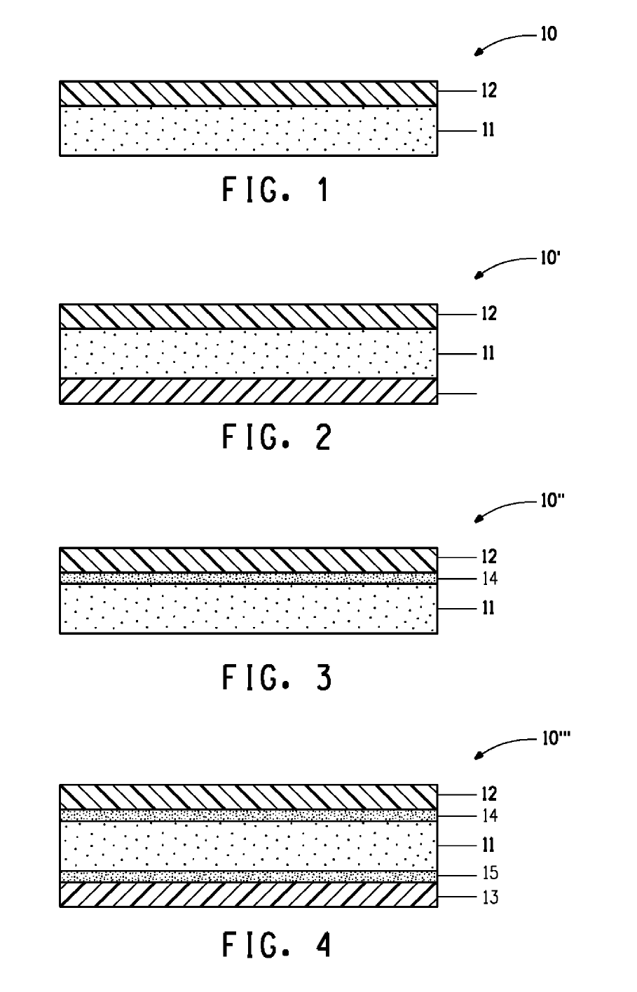

In accordance to the present disclosure, adhesive layer(s) also may be included between any pair of adjacent component layers of the flame resistant flexible backsheet to provide sufficient bonding. For example, as shown in FIG. 3, an adhesive layer (14) may be included between the flame resistant layer (11) and the first polymeric layer (12), and as shown in FIG. 4, first and second adhesive layers (14, 15) may be included between the flame resistant layer (11) and the first polymeric layer (12) and between the flame resistant layer (11) and the second polymeric layer (13), respectively.

Suitable adhesives include, without limitation, reactive adhesives (e.g., polyurethane, acrylic, epoxy, polyimide, or silicone adhesives) and non-reactive adhesives (e.g., polyethylenes (including ethylene copolymers) or polyesters). Exemplary ethylene copolymers used herein as adhesives include, without limitation, ethylene-vinyl acetate copolymers (EVA), ethylene acrylate copolymers, and ethylene-maleic anhydride copolymers. In one embodiment, the adhesives used herein are selected from polyurethane based adhesives and ethylene copolymer based adhesives.

Polyurethane based adhesives are well known within the art and may be obtained commercially from Mitsui Chemicals, Inc. (Japan) under the trade name Takenate™ or Dow Chemical Company (U.S.A.) under the trade name Mor-Free™.

Ethylene copolymer based adhesives are also well known within the art and commercially available. For example, Bynel® 2100 series resins, Bynel® 2200 series resins, Bynel® 3000 series resins, Bynel® 3100 series resins, and Bynel® 3800 series resins from DuPont may be used herein. The adhesive layers (14, 15) may have a thickness of about 1-400 μm, or about 5-200 μm, or about 8-100 μm. In those embodiments where polyurethane based adhesives are used, the thickness of the adhesive layers (14, 15) may be about 1-100 μm, or about 8-50 μm, or about 8-30 μm, while in those embodiments wherein ethylene acrylate copolymer based adhesives are used, the thickness of the adhesive layers (14, 15) may be about 10-400 μm, or about 15-300 μm, or about 20-200 μm.

In one embodiment (see FIG. 3), the flame resistant flexible backsheet (10″) comprises a flame resistant layer (11) that is formed of a glass fiber fabric and a polymeric layer (12) that is formed of a polyester film or sheet (e.g., a film or sheet consisting essentially of PET) and adhered to one side of the flame resistant layer (11). In such an embodiment, an adhesive layer (14) may be included between the flame resistant layer (11) and the polymeric layer (12).

In further embodiment (see FIG. 3), the flame resistant flexible backsheet (10″) comprises a flame resistant layer (11) that is formed of a glass fiber fabric and a polymeric layer (12) that is formed of a fluoropolymer film or sheet (e.g., a film or sheet consisting essentially of PVF) and adhered to one side of the flame resistant layer (11). In such an embodiment, an adhesive layer (14) may be included between the flame resistant layer (11) and the polymeric layer (12).

In a yet further embodiment (see FIG. 4), the flame resistant flexible backsheet (10′″) comprises a flame resistant layer (11) that is formed of a glass fiber fabric, a first polymeric layer (12) that is formed of a polyester film or sheet (e.g., a film or sheet consisting essentially of PET) and adhered to one side of the flame resistant layer (11), and a second polymeric layer (13) that is formed of a fluoropolymer film or sheet (e.g., a film or sheet consisting essentially of PVF) and adhered to the other side of the flame resistant layer (11). In such an embodiment, a first and a second adhesive layer (14, 15) may be included between the flame resistant layer (11) and the first polymeric layer (12) and between the flame resistant layer (11) and the second polymeric layer (13), respectively.

In a yet further embodiment, (see FIG. 3) the flame resistant flexible backsheet (10″) comprises a flame resistant layer (11) that is formed of a ceramic fiber fabric and a polymeric layer (12) that is formed of a polyester film or sheet (e.g., a film or sheet consisting essentially of PET) and adhered to one side of the flame resistant layer (11). In such an embodiment, an adhesive layer (14) may be included between the flame resistant layer (11) and the polymeric layer (12).

In a yet further embodiment (see FIG. 3), the flame resistant flexible backsheet (10″) comprises a flame resistant layer (11) that is formed of a ceramic fiber fabric and a polymeric layer (12) that is formed of a fluoropolymer film or sheet (e.g., a film or sheet consisting essentially of PVF) and adhered to one side of the flame resistant layer (11). In such an embodiment, an adhesive layer (14) may be included between the flame resistant layer (11) and the polymeric layer (12).

In a yet further embodiment (see FIG. 4), the flame resistant flexible backsheet (10′″) comprises a flame resistant layer (11) that is formed of a ceramic fiber fabric, a first polymeric layer (12) that is formed of a polyester film or sheet (e.g., a film or sheet consisting essentially of PET) and adhered to one side of the flame resistant layer (11), and a second polymeric layer (13) that is formed of a fluoropolymer film or sheet (e.g., a film or sheet consisting essentially of PVF) and adhered to the other side of the flame resistant layer (11). In such an embodiment, a first and a second adhesive layer (14, 15) may be included between the flame resistant layer (11) and the first polymeric layer (12) and between the flame resistant layer (11) and the second polymeric layer (13), respectively.

And, in accordance to the present disclosure, the flame resistant flexible backsheet disclosed herein may be prepared by any lamination process, such as extrusion lamination, or vacuum lamination. In one embodiment, the lamination process includes, positioning all component layers of the flame resistant flexible backsheet to form a pre-lamination assembly and then subjecting the pre-lamination assembly to vacuum lamination at 120-170° C. and about 1 atm for about 8-30 minutes.

In those embodiments wherein adhesive layer(s) (14, 15) are included in the flame resistant flexible backsheet (10), suitable adhesives may be first applied over one or both of the adjacent layers by any suitable methods before the pre-lamination assembly is prepared and subjected to lamination. For example, in one embodiment wherein polyurethane based adhesive is employed, the adhesive may be applied by solvent casting. In a further embodiment wherein ethylene acrylate copolymer based adhesives are employed, the adhesives may be applied by extrusion coating.

As demonstrated by the examples below, flexible backsheets for solar cell modules without the flame resistant layer often have poor flame resistance (see e.g., CE1). By including a flame resistant layer made from mica sheets (CE2), short glass fibers (CE3), or ceramic fiber papers (CE4), although the flame resistance of the backsheets is very much improved, the cohesive bonding strength of the backsheets is also reduced dramatically. However, it has been found herein that when a flame resistant layer made from non-metal inorganic fiber fabric is used (see e.g., E1-E4), that not only is the flame resistance of the backsheet improved, but that the bonding integrity of the backsheet also remains good.

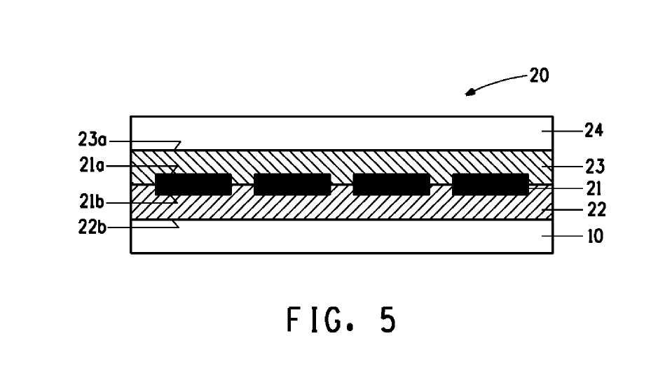

Further disclosed herein are solar cell modules (20, FIG. 5) comprising the flame resistant flexible backsheet disclosed hereabove. In such embodiments, the solar cell module (20) may comprise a solar cell layer (21) formed of one or a plurality of solar cells, a back encapsulant layer (22) laminated to a backside (21b) of the solar cell layer (21), and the flame resistant flexible backsheet (10) laminated to a backside (22b) of the back encapsulant layer (22).

The solar cell(s) in the solar cell layer (21) may be any photoelectric conversion device that can convert solar radiation to electrical energy. They may be formed of photoelectric conversion bodies with electrodes formed on both main surfaces thereof. The photoelectric conversion bodies may be made of any suitable photoelectric conversion materials, such as, crystal silicon (c-Si), amorphous silicon (a-Si), microcrystalline silicon (μ-Si), cadmium telluride (CdTe), copper indium selenide (CuInSe₂ or CIS), copper indium/gallium diselenide (CuInₓGa₍₁₋ₓ₎Se₂ or CIGS), light absorbing dyes, and organic semiconductors. The front electrodes may be formed of conductive paste, such as silver paste, and applied over the front surface of the photoelectric conversion body by any suitable printing process, such as screen printing or ink-jet printing. The front conductive paste may comprise a plurality of parallel conductive fingers and one or more conductive bus bars perpendicular to and connecting the conductive fingers, while the back electrodes may be formed by printing metal paste over the entire back surface of the photoelectric conversion body. Suitable metals forming the back electrodes include, but are not limited to, aluminum, copper, silver, gold, nickel, cadmium, and alloys thereof.

When in use, the solar cell layer (21) typically has a front (or top) surface facing toward the solar radiation and a back (or bottom) surface facing away from the solar radiation. Therefore, each component layer within a solar cell module (20) has a front surface (or side) and a back surface (or side).

The solar cell modules (20) disclosed herein may further comprise a transparent front encapsulant layer (23) laminated to a front surface (21a) of the solar cell layer (21), and a transparent frontsheet (24) further laminated to a front surface (23a) of the front encapsulant layer (23).

Suitable materials used in forming the back encapsulant layer (22) and/or the transparent front encapsulant layer (23) include, without limitation, polyolefins, poly(vinyl butyral) (PVB), polyurethane (PU), polyvinylchloride (PVC), acrylic acid copolymers, silicone elastomers, epoxy resins, and the like. Suitable polyolefins used herein may include, without limitation, polyethylenes, ethylene vinyl acetates (EVA), ethylene acrylate copolymers (such as poly(ethylene-co-methyl acrylate) and poly(ethylene-co-butyl acrylate)), ionomers, polyolefin block elastomers, and the like. In one embodiment, the encapsulant layers (22, 23) are formed of EVA based compositions. EVA based encapsulant materials can be commercially obtained from Bridgestone (Japan) under the trade name EVASKY™; Sanvic Inc. (Japan) under the trade name Ultrapearl™; Bixby International Corp (U.S.A.) under the trade name BixCure™; or RuiYang Photovoltaic Material Co. Ltd. (China) under the trade name Revax™. In a further embodiment, the encapsulant layers (22, 23) are formed of PVB based compositions. PVB based encapsulant materials include, without limitation, DuPont™ PV5200 series encapsulant sheets from DuPont. In a yet further embodiment, the encapsulant layers (22, 23) are formed of ionomer based compositions. Exemplary ionomer based encapsulant materials include, without limitation, DuPont™ PV5300 series encapsulant sheets and DuPont™ PV5400 series encapsulant sheets from DuPont.

Any suitable glass or plastic sheets can be used herein as the transparent frontsheet (24). Suitable plastic materials in the frontsheet (24) may include, without limitation, glass, polycarbonate, acrylics, polyacrylate, cyclic polyolefins, ethylene norbornene polymers, metallocene-catalyzed polystyrene, polyamides, polyesters, fluoropolymers and the like and combinations thereof.

Any suitable lamination process may be used to produce the solar cell modules (20) disclosed herein. In one embodiment, the process includes: (a) providing a plurality of electrically interconnected solar cells to form a solar cell layer (21); (b) forming a pre-lamination assembly wherein the solar cell layer (21) is laid over a back encapsulant layer (22), which is further laid over the flame resistant flexible backsheet (10); and (c) laminating the pre-lamination assembly under heat and optional pressure and/or vacuum to obtain the solar cell module (20).

In a further embodiment, the process includes: (a) providing a plurality of electrically interconnected solar cells to form a solar cell layer (21); (b) forming a pre-lamination assembly wherein the solar cell layer (21) is sandwiched between a transparent front encapsulant layer (23) and a back encapsulant layer (22), which is further sandwiched between a transparent frontsheet (24) and the flame resistant flexible backsheet (10); and (c) laminating the pre-lamination assembly under heat and optional pressure and/or vacuum to obtain the solar cell module (20).

In one embodiment, the lamination process is performed using a ICOLAM 10/08 laminator purchased from Meier Solar Solutions GmbH (Germany) at about 135° C.-150° C. and about 1 atm for about 10-25 minutes.

### EXAMPLES

### Materials:

Glass Sheet (GS): 3.2 mm thick tempered glass purchased from Dongguan CSG Solar Glass Co., Ltd. (China);
EVA Sheet (EVA): Revax™ 767 ethylene vinyl acetate (EVA) sheet (500 μm thick) obtained from RuiYang Photovoltaic Material Co. Ltd. (China);
PET Film-1 (PET-1): Mylar® polyethylene terephthalate (PET) film (188 μm thick) obtained from DuPont Teijin Films (USA);
PET Film-2 (PET-2): Mylar® polyethylene terephthalate (PET) film (100 μm thick) obtained from DuPont Teijin Films (USA);
PVF Film (PVF): Tedlar® polyvinyl fluoride (PVF) film (25 μm thick) obtained from DuPont;
EA Adhesive (EA): Bynel® 22E757 ethylene acrylate copolymer resin obtained from DuPont;
Mica Sheet-1 (MS-1): mica sheet (125 μm thick and with grade name PCM5460-G) obtained from Pamica Electric Material (Hubei) Co., Ltd. (China) with grade name PCM5460-G;
Short Glass Fiber (SGF): Short glass fiber 187H (2-8 mm long), obtained from Nippon Electric Glass Co Ltd;
Glass Fiber Fabric-1 (GFF-1): 100 μm thick woven fabric made from long continuous glass fibers, which was obtained from Shaanxi HuaTek Fiberglass Material Group CO., Ltd. (China);
Glass Fiber Fabric-2 (GFF-2): 100 μm thick woven fabric made from long continuous glass fibers having a SiO₂ content of ≧96%, which was obtained from Shaanxi HuaTek Fiberglass Material Group CO., Ltd. (China) with the grade name BWT100;
Glass Fiber Fabric-3 (GFF-3): 100 μm thick woven fabric made from long continuous glass fibers having a SiO₂ content of ≧96%, which was obtained from Shaanxi HuaTek Fiberglass Material Group CO., Ltd. (China) with the grade name BWT260;
TPE Film (TPE): Solmate™ BTNE TPE backsheet obtained from Taiflex Scientific Co., Ltd. (Taiwan), which had a tri-layer structure of “Tedlar® PVF #2111 film/PET film/EVA sheet” (PVF/PET/EVA) with adhesive used between each adjacent layer.
Ceramic Fiber Paper (CFP): 1 mm thick ceramic fiber paper made of short ceramic fibers (with an average fiber length of <1 cm), which was obtained from Jinshi High Temperature Materials Co, Ltd. (China) with grade name JSGW-236;
Perforated Ceramic Fiber Paper (PCFP): obtained by forming multiple apertures on a layer of CFP using a die-cutting method. The multiple apertures each had a diameter of about 1 mm and were spaced about 7 mm apart from adjacent apertures.
Ceramic Fiber Fabric (CFF): 2 mm thick woven fabric made from long continuous ceramic fibers, which was obtained from Jinshi High Temperature Materials Co, Ltd. (China) with the grade name JSGW-208C2.

### Test Methods:

Bonding Strength Test: The bonding strength of the laminated sheets was determined following modified ASTM F88, wherein the sample width was set at 2.54 cm and the peeling speed at 12.7 cm/min.
Flammability Test: The flame resistant properties of the laminated sheets were determined as follows, (a) placing a sheet sample (10×7 cm) about 10 cm above a flame (with the flame intensity set at 5V according to UL94); (b) maintaining the sample above the flame with its polymer side down for 60 seconds.
Partial Discharge Test: Partial discharge tests were performed following ASTM D1868 at 23° C. and 50% relative humidity (50% RH) using a Partial Discharge Detector DDX 9101 from Hubbell Incorporated (USA).
Breakdown Voltage Test: Breakdown voltage test were performed following ASTM D149 at 23° C. and 50% RH using a 700-D149-P series AC Dielectric Breakdown Tester from Hubbell Incorporated.
Water Vapor Transmission Rate (WVTR) Test: WVTR tests were performed following ASTM F1249 at 38° C., 100% RH, and a flow rate of 10 cc using a PERMATRAN-W™ Model 700 water vapor transmission rate testing system from Mocon Inc. (USA).

### Comparative Examples CE1-CE3 and Examples E1-E3

In CE1, a laminated tetra-layer sheet, which had a dimension of 10×7 cm and is denoted herein as “PVF/PET-1/EVA/GS”) was prepared. The laminated tetra-layer sheet of CE1 comprised a layer of PVF Film that was bonded to a layer of PET-1 Film, which was further bonded to a layer of EVA Sheet, which was further bonded to a layer of Glass Sheet. First, a 40 μm thick coat of EA Adhesive was extrusion coated over a first surface of the PVF Film while a 120 μm thick coat of EA Adhesive and a 60 μm thick coat of EA Adhesive were extrusion coated over a first and a second surface of the PET Film-1, respectively. Thereafter, the coated PET Film-1 was placed between the PVF Film and the EVA Sheet with the coated first surface of the PVF film in contact with the coated first surface of the PET Film-1, and the Glass sheet was placed over the EVA Sheet. The as described tetra-layer assembly was then vacuum laminated using a Meier ICOLAM™ 10/08 laminator (Meier Vakuumtechnik GmbH, Germany) at a pressure of 1 atm and a temperature of 145° C. for 15 minutes to form the final laminated tetra-layer sheet of “PVF/PET-1/EVA/GS”.

In CE2, a laminated penta-layer sheet which is denoted herein as “PVF/MS/PET-1/EVA/GS” was prepared. The laminated penta-layer sheet of CE2 had a structure similar to that of the laminated tetra-layer sheet of CE1, with the exception that a layer of Mica Sheet was included and bonded between the PVF Film and the PET Film-1. First, a 40 μm thick coat of EA Adhesive was extrusion coated on a first surface of the PVF Film and a 120 μm thick coat of EAAdhesive and a 60 μm thick coat of EA Adhesive were extrusion coated over a first and second surfaces of the PET Film-1, respectively. Then, Mica Sheet was placed between the PVF Film and the PET Film-1 (with the first coated surface of the PVF Film and the first coated surface of the PET Film-1 in contact with Mica Sheet), the EVA Sheet was placed over the PET Film-1 and the Glass Sheet over the EVA Sheet to form a penta-layer structure. Thereafter, the penta-layer structure was vacuum laminated using a Meier Vakuumtechnick GMBG laminator under 1 atm and 145° C. for 15 minutes to form the final laminated penta-layer sheet of “PVF/MS/PET-1/EVA/GS”.

In CE3, a laminated penta-layer sheet that is denoted herein as “PVF/SGF/PET-1/EVA/GS” was prepared. The laminated penta-layer sheet of CE3 had a structure similar to that of the laminated tetra-layer sheet of CE1, with the exception that a layer of Short Fiber Glass was included and bonded between the PVF Film and the PET Film-1. First, a 40 μm thick coat of EA Adhesive was extrusion coated on a first surface of the PVF Film and a 120 μm thick coat of EAAdhesive and a 60 μm thick coat of EA Adhesive were extrusion coated over a first and second surfaces of the PET Film-1, respectively. Then, the EVA sheet was laid over the glass sheet and the PET Film-1 was laid over the EVA sheet with its second surface in contact with the EVA sheet. A layer of Short Glass Fibers were laid over the first surface of the PET Film-1 with a condensed thickness of 400 μm. Thereafter, the PVF Film was laid over the chopped glass fiber layer with the first surface of the PVF film facing the chopped glass fiber layer. Finally, the penta-layer structure was vacuum laminated using a Meier Vakuumtechnick GMBG laminator under 1 atm and 145° C. for 15 minutes to form the final laminated penta-layer sheet of “PVF/SGF/PET-1/EVA/GS”.

In E1, a laminated penta-layer sheet that is denoted herein as “PVF/GFF-1/PET-1/EVA/GS” was prepared. The laminated penta-layer sheet in E1 has a structure similar to that of the laminated penta-layer sheet in CE2, with the exception that a layer of Glass Fiber Fabric-1 was included and bonded between the PVF Film and the PET Film-1 in place of Mica Sheet.

In E2, a laminated penta-layer sheet that is denoted herein as “PVF/GFF-2/PET-1/EVA/GS” was prepared. The laminated penta-sheet layer in E2 has a structure similar to that of the laminated penta-layer sheet in CE2, with the exception that a layer of Glass Fiber Fabric-2 was included and bonded between the PVF Film and the PET Film-1 in place of Mica Sheet.

In E3, a laminated penta-layer sheet that is denoted herein as “PVF/GFF-3/PET-1/EVA/GS” was prepared. The laminated penta-sheet layer in E3 has a structure similar to that of the laminated penta-layer sheet in CE2, with the exception that a layer of Glass Fiber Fabric-3 was included and bonded between the PVF Film and the PET Film-1 in place of Mica Sheet.

As shown in Table 1, laminated sheets made of polymers and glass (CE1) has very poor flame resistance. With the addition of a layer of mica sheet (CE2) or a layer of condensed short glass fibers (CE3), the laminated sheets had much improved flame resistance, but the bonding integrity thereof was decreased. However, by using glass fiber fabrics (E1-E3), the laminated sheets, not only had excellent flame resistance, but they also had good bonding integrity.

TABLE 1

| | | Flame | | |
|---|---|---|---|---|
| | | Resis- | Bonding | |
| Sam- | | tant | Strength | ⁵Flame |
| ples | Structure | Layer | (N/cm) | Resistance |
| CE1 | PVF/PET-1/EVA/GS | — | ¹11.0 | Poor |
| CE2 | PVF/MS/PET-1/EVA/GS | MS | ^{2,3}0.9 | Excellent |
| CE3 | PVF/SGF/PET-1/EVA/GS | SGF | ^{2,3}0 | Good |
| E1 | PVF/GFF-1/PET-1/EVA/GS | GFF-1 | ⁴9.8/11.8 | Excellent |
| E2 | PVF/GFF-2/PET-1/EVA/GS | GFF-2 | ⁴10.2/11.8 | Excellent |
| E3 | PVF/GFF-3/PET-1/EVA/GS | GFF-3 | ⁴9.0/12.6 | Excellent |

¹The value is the 180° bonding strength between PVF Film layer and PET Film-1 layer;
²The value is the 180° bonding strength between PVF Film layer and the flame resistant layer;
³Cohesive failure at the flame resistant layer was observed;
⁴The first value is the 180° bonding strength between the PVF Film layer and the flame resistant layer, while and second value is the 180° bonding strength between the flame resistant layer and the PET Film-1 layer;
⁵Flame Resistance: measured following the flammability test described above; “Excellent” - none of the 3 samples were ignited and no polymer melt drops were observed in any of the 3 samples; “Good” - only 1 of 3 samples was ignited with the flame extinguished gradually after removal of the burner and no polymer melt drops were observed in any of the 3 samples; and “Poor” - all 3 samples were ignited and the flame continued until all the polymeric materials were burned away in all 3 samples.

### Comparative Example CE4 and Example E4

In CE4, a laminated penta-layer sheet that is denoted herein as “PVF/CFP/PET-2/EVA/GS” was prepared. The laminated penta-layer sheet in CE4 has a structure similar to that of the laminated penta-layer sheet in CE2, with the exception that a layer of Ceramic Fiber Paper were included and bonded between the PVF Film and the PET Film-2 in place of Mica Sheet. First, a 40 μm thick coat of EAAdhesive was extrusion coated over a first surface of the PVF Film while a 75 μm thick coat of EA Adhesive and a 60 μm thick coat of EAAdhesive were extrusion coated over a first and a second surface of the PET Film-2, respectively. Then, a layer of CFP was placed between the PVF Film and the PET Film-2 (with the first coated surface of the PVF Film and the first coated surface of the PET Film-2 in contact with CFP), the EVA Sheet was placed over the PET Film and the Glass Sheet over the EVA Sheet to form a penta-layer structure. The as described tetra-layer assembly was then vacuum laminated using a Meier ICOLAM™ 10/08 laminator (Meier Vakuumtechnik GmbH, Germany) at a pressure of 1 atm and a temperature of 145° C. for 15 minutes to form the final laminated penta-layer sheet of “PVF/CFP/PET-2/EVA/GS”.

In E4, a laminated penta-layer sheet that is denoted herein as “PVF/CFF/PET-2/EVA/GS” was prepared. The laminated penta-layer sheet in E4 has a structure similar to that of the laminated sheet in CE4, with the exceptions that a layer of Ceramic Fiber Fabric was included in place of the Ceramic Fiber Paper layer.

As shown in Table 2, with the addition of a layer of ceramic fiber paper (CE4), the laminated sheet had much improved flame resistance, but the bonding integrity thereof was decreased. However, by using ceramic fiber fabric (E4), the laminated sheet not only had excellent flame resistance, but it also had good bonding integrity.

TABLE 2

| | | Flame | | |
|---|---|---|---|---|
| | | Resis- | ¹Bonding | |
| Sam- | | tant | Strength | ⁴Flame |
| ples | Structure | Layer | (N/cm) | Resistance |
| CE4 | PVF/CFP/PET-2/EVA/GS | CFP | ^{1,2}0 | Good |
| E4 | PVF/CFF/PET-2/EVA/GS | CFF | ³9.0/11.0 | Excellent |

¹The value is the 180° bonding strength between PVF Film layer and the flame resistant layer;
²Cohesive failure at the flame resistant layer was observed;
³The first value is the 180° bonding strength between the PVF Film layer and the flame resistant layer, while and second value is the 180° bonding strength between the flame resistant layer and the PET Film-1 layer;
⁴Flame Resistance: measured following the flammability test described above; “Excellent” - none of the 3 samples were ignited and no polymer melt drops were observed in any of the 3 samples; and “Good” - only 1 of 3 samples was ignited with the flame extinguished gradually after removal of the burner and no polymer melt drops were observed in any of the 3 samples.

### Comparative Examples CE5-CE6 and Examples E5-E8

The tri-layer TPE Film used in CE5 was a solar cell backsheet obtained from Taiflex Scientific Co Ltd. under the trade name Somate® BTNE.

CE6, a laminated bi-layer sheet (structure detailed in Table 3) was prepared following the same procedure described above in CE1 without the addition of the EVA Sheet and the Glass Sheet.

In each of E5-E7, laminated tri-layer sheets (structures detailed in Table 3) were prepared following the same procedure described above in CE2 without the addition of the EVA Sheet and the Glass Sheet. The laminated tri-layer sheet in E8 was prepared following the same procedure described above in E4 without the addition of the EVA Sheet and the Glass Sheet.

The laminated multi-layer sheets in CE5-CE6 and E5-E8 were then subject to partial discharge test, breakdown voltage test, and water vapor transmission rate (WVTR) test. Results are tabulated in Table 3 below.

It is demonstrated that the laminated sheets including glass fiber fabrics or ceramic fiber fabrics had a partial discharge and a breakdown voltage comparable to that of prior TPE backsheets. In addition, the water vapor transmission rate (WVTR) of the laminated sheets with glass fiber fabrics or ceramic fiber fabrics were comparable or even lower than that of the conventional TPE backsheets.

TABLE 3

| | | Partial | Breakdown | |
|---|---|---|---|---|
| Sam- | | Discharge | Voltage | WVTR |
| ples | Structure | (kV) | (kV) | (g/m²-day) |
| CE5 | Somate ® BTNE TPE | 1.216 | 24.22 | 3.44 |
| CE6 | PVF/PET-1 | 1.52 | 24.84 | 2.31 |
| E5 | PVF/GFF-1/PET-1 | 1.62 | 26.31 | 2.14 |
| E6 | PVF/GFF-2/PET-1 | 1.91 | 27.33 | 1.9 |
| E7 | PVF/GFF-3/PET-1 | 1.63 | 27.29 | 2.31 |
| E8 | PVF/CFF/PET-2 | 1.66 | 18.76 | 3.45 |

What is claimed is:

1. A flame resistant flexible backsheet for solar cell modules, which comprises: (a) a flame resistant layer formed of a non-metal inorganic fiber fabric; and (b) a first polymeric layer that is adhered to a first side of the flame resistant layer.

2. The flame resistant flexible backsheet of claim 1, wherein the non-metal inorganic fiber fabric is made from long continuous non-metal inorganic fibers.

3. The flame resistant flexible backsheet of claim 2, wherein the long continuous non-metal inorganic fibers are formed of a material selected from the group consisting of silica, boron oxide, aluminum silicate, alumino borosilicate, calcium silicate, magnesium silicate, silicon carbide, zirconium carbide, potassium titanates, aluminum borosilicates, anthophyllite, amphibole, serpentine and aluminum oxide, magnesium oxide, calcium oxide, zirconium oxide, titanium oxide, or combinations of two or more thereof.

4. The flame resistant flexible backsheet of claim 1, wherein the non-metal inorganic fiber fabric is selected from the group consisting of woven fabrics, non-woven fabrics, and knitted fabrics.

5. The flame resistant flexible backsheet of claim 1, wherein the non-metal inorganic fiber fabric is a woven fabric made from long continuous non-metal inorganic fibers selected from glass fibers, ceramic fibers, and combinations thereof.

6. The flame resistant flexible backsheet of claim 1, wherein the flame resistant layer has a thickness of 0.01-5 mm.

7. The flame resistant flexible backsheet of claim 1, wherein the first polymeric layer is formed of a composition comprising a polymeric material selected from the group consisting of fluoropolymers, polyesters, polycarbonates, polyolefins, ethylene copolymers, polyvinyl butyrals, norbornene copolymers, polystyrenes, styrene-acrylate copolymers, acrylonitrile-styrene copolymers, polyacrylates, polyethersulfones, polysulfones, polyamides, polyurethanes, acrylics, cellulose acetates, cellulose triacetates, cellophanes, polyvinyl chlorides, vinylidene chloride copolymers, epoxy, and combinations of two or more thereof.

8. The flame resistant flexible backsheet of claim 7, wherein the first polymeric layer is formed of a composition comprising a fluoropolymer or a polyester.

9. The flame resistant flexible backsheet of claim 1, which further comprises (c) a second polymeric layer that is adhered to a second side of the flame resistant layer that is opposite from the first side of the flame resistant layer.

10. The flame resistant flexible backsheet of claim 9, wherein each of the first and second polymeric layer is independently formed of a composition comprising a polymeric material selected from the group consisting of fluoropolymers, polyesters, polycarbonates, polyolefins, ethylene copolymers, polyvinyl butyrals, norbornene copolymers, polystyrenes, styrene-acrylate copolymers, acrylonitrile-styrene copolymers, polyacrylates, polyethersulfones, polysulfones, polyamides, polyurethanes, acrylics, cellulose acetates, cellulose triacetates, cellophanes, polyvinyl chlorides, vinylidene chloride copolymers, epoxy, and combinations of two or more thereof.

11. The flame resistant flexible backsheet of claim 10, wherein each of the first and second polymeric layers is independently formed of a composition comprising a fluoropolymer or a polyester.

12. The flame resistant flexible backsheet of claim 7, wherein the fluoropolymer is selected from the group consisting of homopolymers and copolymers of vinyl fluorides (VF), vinylidene fluorides (VDF), tetrafluoroethylenes (TFE), hexafluoropropylenes (HFP), chlorotrifluoroethlyenes (CTFE), and combinations of two or more thereof.

13. The flame resistant flexible backsheet of claim 7 wherein the fluoropolymer is selected from the group consisting of polyvinyl fluorides (PVF), polyvinylidene fluorides (PVDF), polytetrafluoroethylene (PTFE), ethylene chlorotrifluoroethlyene copolymers (ECTFE), ethylene tetrafluoroethylene copolymers (ETFE), and combinations of two or more thereof.

14. The flame resistant flexible backsheet of claim 7, wherein the polyester is selected from the group consisting of polyethylene terephthalate (PET), polybutylene terephthalate (PBT), polyethylene trimethylene terephthalate (PTT), polyethylene naphthalates (PEN), and combinations of two or more thereof.

15. The flame resistant flexible backsheet of claim 11, wherein the flame resistant layer is formed of a woven glass fiber fabric; the first polymeric layer is formed of a composition comprising a fluoropolymer; and the second polymeric layer is formed of a composition comprising a polyester.

16. The flame resistant flexible backsheet of claim 11, wherein the flame resistant layer is formed of a woven ceramic fiber fabric; the first polymeric layer is formed of a composition comprising a fluoropolymer; and the second polymeric layer is formed of a composition comprising a polyester.

17. The flame resistant flexible backsheet of claim 8, which further comprises one or more adhesive layers, and wherein each of the one or more adhesive layers is disposed between any pair of adjacent layers.

18. The flame resistant flexible backsheet of claim 17, wherein each of the one or more adhesive layers is independently formed of an adhesive material selected from the group consisting of reactive adhesives and non-reactive adhesives.

19. A solar cell module comprising a solar cell layer formed of one or a plurality of solar cells, a back encapsulant layer laminated to a back side of the solar cell layer, and a backsheet laminated to a back side of the back encapsulant layer, wherein the backsheet is formed of the flame resistant flexible backsheet recited in claim 1.

20. The solar cell module of claim 19, which further comprises a front encapsulant layer laminated to a front side of the solar cell layer and a transparent frontsheet laminated to a front side of the front encapsulant layer.
